(19) United States
(12) Patent Application Publication
(10) Pub. No.: US 2017/0242602 A1
(43) Pub. Date: Aug. 24, 2017

(54) DATA PROCESSING METHOD

(71) Applicant: YANDEX EUROPE AG, Luzern (CH)

(72) Inventor: Grigory Victorovich DEMCHENKO, Moscow (RU)

(21) Appl. No.: 15/505,686

(22) PCT Filed: Dec. 24, 2014
(86) PCT No.: PCT/IB2014/067294

§ 371 Date: Feb. 22, 2017

(30) Foreign Application Priority Data
Sep. 30, 2014 (RU) 2014139545

(51) Int. Cl. G06F 3/06; G06F 9/45; G06F 9/44

(52) U.S. Cl. CPC G06F 3/0619; G06F 3/065; G06F 3/067; G06F 8/37; G06F 8/41

(57) ABSTRACT

A method of data processing comprises a first instance of a computer program allocating a first contiguous portion of memory for storing program heap variables. The first instance processes data including storing variables in the program heap. When the first instance is to cease data processing, the first contiguous portion of memory is copied to persistent memory. A second instance of the computer program allocates a second contiguous portion of memory for storing program heap variables, the second contiguous portion of memory being at least as large as the first contiguous portion of memory. The second instance copies the persistent memory into the second contiguous portion of memory; and resumes processing data based on variables stored in the program heap in the second contiguous portion of memory.

### CROSS-REFERENCE

The present application claims convention priority to Russian Patent Application No. 2014139545, filed Sep. 30, 2014, entitled “A DATA PROCESSING METHOD” which is incorporated by reference herein in its entirety.

### FIELD

The present technology teaches a method of processing intermediate data generated during computer program execution.

### BACKGROUND

There are many instances where it can be desirable to cease computer program execution on a computing apparatus and to subsequently continue execution of that program based on previous computer program execution. For example, it may be desirable to process a large amount of data with a given computer program in discrete stages and possibly on different computing apparatus. Thus, a user may want to start execution on a first computer (an office computer) and to continue execution on a second computer (a home laptop). Alternatively, a user could wish to begin processing on one computer and then complete processing on a different more or less powerful computer, so enabling the first computer to be used for more latency sensitive tasks. In other examples, it may be desirable to move data processing from one computer to another to balance load among a group or cluster of computers. In these cases and others, the user or administrator may want to pause the program execution either by setting pause conditions or manually intervening to indicate program execution should pause.

In any case, a program which is to cease processing and subsequently resume processing needs to preserve the state of execution of the program code (the current memory state of computer). Further, when execution of the code is to resume, the memory state of the first computing device (for particular memory addresses and contents) needs to be restored to enable processing to re-start.

For programs of even moderate complexity, the steps involved in determining which program variables need to be captured, saved and subsequently restored means that bespoke software which needs to be written to enable a program to cease and re-start processing places a burden on software developers and testers who may need to deploy many different programs.

Similarly, the requirement for a program to marshal data stored in memory before serializing the data when the program is to cease processing and conversely to re-load the data when processing resumes can slow the swapping of processing from one instance of a program to another.

U.S. Pat. No. 8,359,437 discloses virtual stacking for a virtual machine environment where a data element is received for storage to a shared memory location and written to the shared memory location. Writing to the shared memory location may be implemented by reading the shared memory location contents, encoding the received data element with the shared memory location contents to derive an encoded representation and writing the encoded representation to the shared memory location so as to overwrite the previous shared memory location contents. The method may further comprise receiving a request for a desired data element encoded into the shared memory location, decoding the shared memory location contents until the desired data element is recovered and communicating the requested data element.

The encoding and decoding of memory information shared between virtual machines can involve significant overhead in facilitating running a computer program in discrete stages.

### SUMMARY

In accordance with a first broad aspect of the present technology, there is provided a data processing method. A first instance of a computer program allocates a first contiguous portion of memory for storing program heap variables. The first instance processes data including storing heap variables in the program heap. When the first instance ceases data processing, the first contiguous portion of memory is copied to persistent memory. A second instance of the computer program allocates a second contiguous portion of memory for storing program heap variables. The second contiguous portion of memory is at least as large as the first contiguous portion of memory. The second instance copies the persistent memory into the second contiguous portion of memory. The second instance resumes processing data based on heap variables stored in the program heap in the second contiguous portion of memory.

In some embodiments, the first instance is instantiated on a first computing apparatus and the second instance is instantiated on a second different computing apparatus.

Alternatively, the first and second computing apparatus are the same computing apparatus.

The persistent memory can comprise one of computer memory or non-volatile memory accessible to each of said first and second instances.

In some embodiments, the first instance stores a program stack in the first contiguous portion of memory; the first instance storing local variables in the stack. The second instance allocates a portion of the second contiguous portion of memory for storing a program stack; and the second instance resumes processing data based on heap variables stored in the program stack in the second contiguous portion of memory.

In some embodiments, the program is a multithreaded program, each thread having its own stack and each stack being stored in the first contiguous portion of memory.

In some embodiments, the first instance stores at least one processor register value in the persistent memory when the first instance is to cease processing; the second instance copying the processor register values from the persistent memory; and the second instance resuming processing data based on said one or more processor register values.

The computer program can comprise a plurality of coroutines, each instance of coroutine being arranged to perform the above method.

In some embodiments, the program comprises a memory allocation function for heap variables replacing a default memory allocation function which would otherwise allocate memory for heap variables in non-contiguous portions of memory.

The program can be a compiled C program implemented with an overloaded malloc( ) function.

Alternatively, the program can be a compiled C++ program implemented with an overloaded new( ) function.

In some embodiments the memory can be virtual memory.

In some embodiments, after ceasing data processing, the program either exits or pauses.

In another aspect there is provided a computer program product comprising executable instructions stored on a computer readable medium which when executed on a computing apparatus are arranged to perform the above method.

In a still further aspect, there is provided a data processing system comprising a first computing apparatus and a second computing apparatus connected via a persistent memory. The first computing apparatus is arranged to first instantiate a computer program and allocate a first contiguous portion of memory for storing program heap variables. The first instance of computer program processes data including storing variables in the program heap. The first instance is responsive to ceasing data processing to copy the first contiguous portion of memory to the persistent memory. The second computing apparatus is arranged to subsequently instantiate the computer program and allocate a second contiguous portion of memory for storing program heap variables. The second contiguous portion of memory is at least as large as the first contiguous portion of memory. The subsequent instance of the computer program copies the persistent memory into the second contiguous portion of memory; and resumes processing data based on variables stored in the program heap in the second contiguous portion of memory.

### BRIEF DESCRIPTION OF THE DRAWINGS

Various embodiments will now be described, by way of example, with reference to the accompanying drawings, in which:

FIG. 1 illustrates schematically a system for distributing data processing between computing apparatus, the system being implemented in accordance with non-limiting embodiments of the present technology;

FIG. 2 illustrates schematically a system for distributing data processing between computing apparatus the system being implemented in accordance with another non-limiting embodiment of the present technology; and

FIG. 3 illustrates a method operable on the apparatus of FIG. 2.

### DESCRIPTION OF THE EMBODIMENTS

Typically when a computer program is instantiated and runs, its footprint in computer memory is divided into a number of main portions:

program code including library code;

program stack;

program heap; and

the program state is also reflected in processor registers, for example, the instruction counter, stack pointer etc.

The stack is region of memory that stores temporary variables created by each active program subroutine, function or procedure (including for example in C or C++ the main( ) function). The stack is also used to keep track of the point to which each active subroutine should return control when it finishes executing and to enable parameter passing between subroutines. This kind of stack is also known as an execution stack, control stack, run-time stack, or machine stack, and in the present specification this is shortened to just “the stack”. Every time a function declares a new variable, it is “pushed” onto the stack. Then every time a function exits, all of the variables pushed onto the stack by that function are freed. Typically, this is achieved by shifting the (top of) stack pointer to its position prior to calling the exiting function. Once memory containing a stack variable is freed, that region of memory becomes available for other variables. It will be appreciated that because when a function exits, all of its variables are regarded as “popped” off the stack, stack variables are local and so are typically not available outside the function.

It will be appreciated that in a multi-threaded program, each thread or coroutine might have its own stack and an implementation involving multiple independent coroutines, each with their own stack is described below.

Typically, runtime libraries linked to program code manage stack memory so that it doesn't have to be explicitly allocated or freed by a program. Thus, although maintenance of the stack is important for the proper functioning of most software, the details are normally hidden and automatic in high-level programming languages. Some computer language instruction sets provide special instructions for manipulating stacks.

It will also be appreciated that as a stack grows, it occupies a contiguous portion of memory. In virtual memory computer systems this can mean that the stack occupies a contiguous portion of virtual memory while the information may be stored in physically separate memory locations.

The heap on the other hand is a region of computer memory whose allocation is not managed automatically, nor is heap memory as tightly managed by the CPU. It is a more free-floating region of memory and is typically larger than the stack. To allocate memory for variables on the heap in a C language program, built-in C functions malloc( ) or calloc( ) are used. In C++, equivalent functions are new( ) and delete( ), with other programming languages using similar functions.

For variables allocated in heap memory, the C function free( ) or C++ function delete( ) can be used to deallocate that memory once that memory is no longer needed. Failing to do this results in memory leakage where memory on the heap will still be set aside and won't be available to other processes. Because of the possibly many allocations and deallocations of heap memory at program run time, in virtual memory systems, heap memory variables may be stored in non-contiguous portions of virtual memory as well as physical memory.

Unlike the stack, the heap typically does not have size restrictions on variable size (apart from the physical limitations of computer memory).

Finally, unlike the stack, variables created on the heap are typically accessible by any function, from anywhere in a program and so heap variables are essentially global in scope.

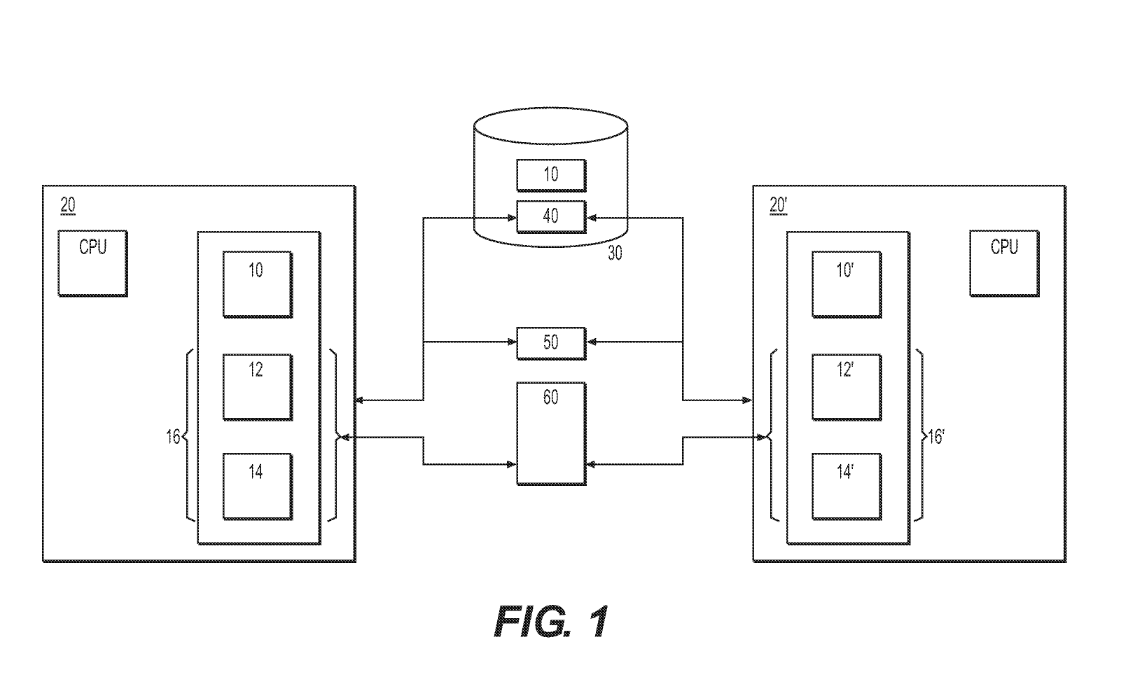

Referring to FIG. 1, there is shown a diagram of a system including apparatus 20 and 20′. It is to be expressly understood that the system is merely one possible implementation of the present technology. Thus, the description thereof that follows is intended to be only a description of illustrative examples of the present technology. This description is not intended to define the scope or set forth the bounds of the present technology. In some cases, what are believed to be helpful examples of modifications to system may also be set forth below.

This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system may provide in certain instances a simple implementation of the present technology, and that where such is the case they have been presented in this manner as an aid to understanding. As persons skilled in the art would understand, various implementations of the present technology may be of a greater complexity.

In a first embodiment, a computing apparatus 20 is communicatively coupled with a data storage device 30 which stores program code 10 for a program. The storage device 30 can be a memory device such as a hard disk integrated with the computing apparatus 20 or the storage device 30 can be connected to the computing apparatus 20 via a network (not depicted) or indeed any suitable wired or wireless connection. In the context of the present specification, unless expressly provided otherwise, “computing apparatus” is any computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, as well as network equipment such as routers, switches, and gateways. It should be noted that a device acting as a computing apparatus in the present context is not precluded from acting as a server to other electronic devices. The use of the expression “a computing apparatus” does not preclude multiple electronic devices being used in receiving/sending, carrying out or causing to be carried out any task or request, or the consequences of any task or request, or steps of any method described herein.

The program 10 is particularly arranged to manage its program heap and stack so that heap variables are written to a pre-determined contiguous portion of (virtual) memory 14, and so that the program stack 12 is written to a specific portion of (virtual) memory 14.

The portion of memory 16 comprising the stack 12 and heap 14 will be referred to herein as the context heap 16.

For programs written in C or C++, controlling the allocation of the program heap can be achieved by overloading the malloc( ) calloc( ) and new( ) functions so that as new variables are declared and allocated at program execution time, they are written to a contiguous portion of memory rather than being distributed across non-contiguous memory locations—both in virtual and physical memory. Equivalent techniques can be employed for programs written in other languages; or indeed other techniques for achieving the same result can be employed according to the operating system environment of the program.

As functions equivalent to malloc( ), calloc( ) and new( ) are not required for allocating stack variables, because these are handled at a level below high level program code, in order to ensure that the program stack is stored in a specific portion of virtual memory 14, it can be necessary to link assembly code routines to the program code, these routines intercepting stack operations to ensure the stack is written to a portion of memory within the context heap 16.

In embodiments, it is desirable to transfer program processing from a first instance of program code 10 to a second instance of program code 10′. As explained above, this can facilitate matching the data processing power of the computing apparatus 20, 20′ to the data 40, 50 which has to be processed, or simply to free up processing resources on the first computing apparatus 10 for a required period of time. As shown for simplicity in FIG. 1, the second instance can be running on a separate computing apparatus 20′; however, the second instance of program code could also be a second instance of the program code 10 running on the same apparatus sometime after the first instance has ceased processing.

It will also be appreciated that the data 40 to be processed by the program can be stored locally in the storage device 30 or fed and/or data 50 received at the apparatus 10 from a remote data source.

In the context of the present specification, unless expressly provided otherwise, the expression “data” includes information of any nature or kind whatsoever capable of being stored, for example, in a database, or transmitted electronically, for example, in a stream. Thus data includes, but is not limited to audiovisual works (images, movies, sound recordings, presentations etc.), location data, numerical data, etc., text (opinions, comments, questions, messages, etc.), documents, spreadsheets, etc.

In the context of the present specification, unless expressly provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In any case, the first instance of the program code 10 starts code execution in respect of a portion of data. The first instance of program code 10 allocates both its program stack 12 and heap 14 in a pre-determined portion of memory 16.

The first instance of the program 10 finishes (or pauses) code execution, with an intermediate data portion stored within the context heap 16.

Normally, in order to have the intermediate data available to subsequent instances of the program 10, dedicated program code would have to specifically marshal variable and object values required for subsequent processing on a case by case basis and write this information to storage, for example, in a save file. Alternatively, the program 10 could save an intermediate execution stage using some special stage marks or execution points to correctly continue the execution from saved information. The process would then need to be reversed for a subsequent instance of the program to resume processing so placing a large burden on the program developer(s); and resulting in slower ceasing and resumption of program processing.

In the present case, the context heap 16 containing the program stack 12 and heap 14 can be stored directly in a memory 60 so that it can be available when processing resumes. This can be done by first copying the context heap 16 to more persistent memory i.e. volatile memory which will not be released when the instance of the program 10 exits; or writing the context heap to non-volatile storage, for example, the data storage device 30. This copying need not involve any pre-processing of the context heap and it can be copied directly to persistent memory. Nonetheless, in some implementations it can be useful to, for example, carry out compression of the context heap memory 16 if the storage saving gained by compression merited the processing requirement to compress and subsequently decompress the data. In FIG. 1, the stored version of the context heap is indicated by the numeral 60 and the only requirement is that the stored version of the context heap 60 be accessible to any subsequent instance of the program which is to continue processing of the data 40, 50 based on the intermediate data stored in the context heap 16 at the time program processing ceased (either by finishing or pausing). (Note that when the program 10 finally exits, any memory allocated by the program including the context heap is freed and so any information stored in that memory is not available to subsequent programs.)

In any case, the second instance of the program 10′ running subsequently begins by allocating a contiguous portion of memory 16′ sufficient to store the context heap 16. This can be the same pre-determined or fixed region of memory as used originally. The second instance of the program 10′ then copies the stored version of the context heap 60 into context heap memory 16′.

It is appreciated that restoring the program stack 12 and heap 14 alone may not be sufficient to enable program processing to resume and that for example, certain processor register information also needs to be copied from the first instance of the computer program 10 to the subsequent instance of computer program 10′. These registers can include, for example, the stack pointer indicating the extent of the stack within the context heap 16′, possibly the instruction counter indicating where processing had actually stopped within the first instance of the computer program 10, as well as any other register information which might be required to reliably resume processing within a second or subsequent instance of the computer program. Nonetheless, it will be seen that the register information which needs to be captured and restored can be the same from program to program and that as such dedicated functions can be made available to save this information with the context heap 16 when program processing ceases and to restore this information when processing resumes. This functionality can be incorporated within context save and context restore functions which execute when a program ceases and resumes processing respectively, so imposing little burden on a developer when incorporating this functionality with their program code.

Once the registers have been restored as required, program processing of the second instance of the program 10′ can continue until this is to cease processing after which still further instances of the program can continue processing if required.

The above example relates to a single program thread where there is one stack associated with a running program.

In other implementations, as described below, a dedicated stack and heap can be associated with respective tasks running within a single program.

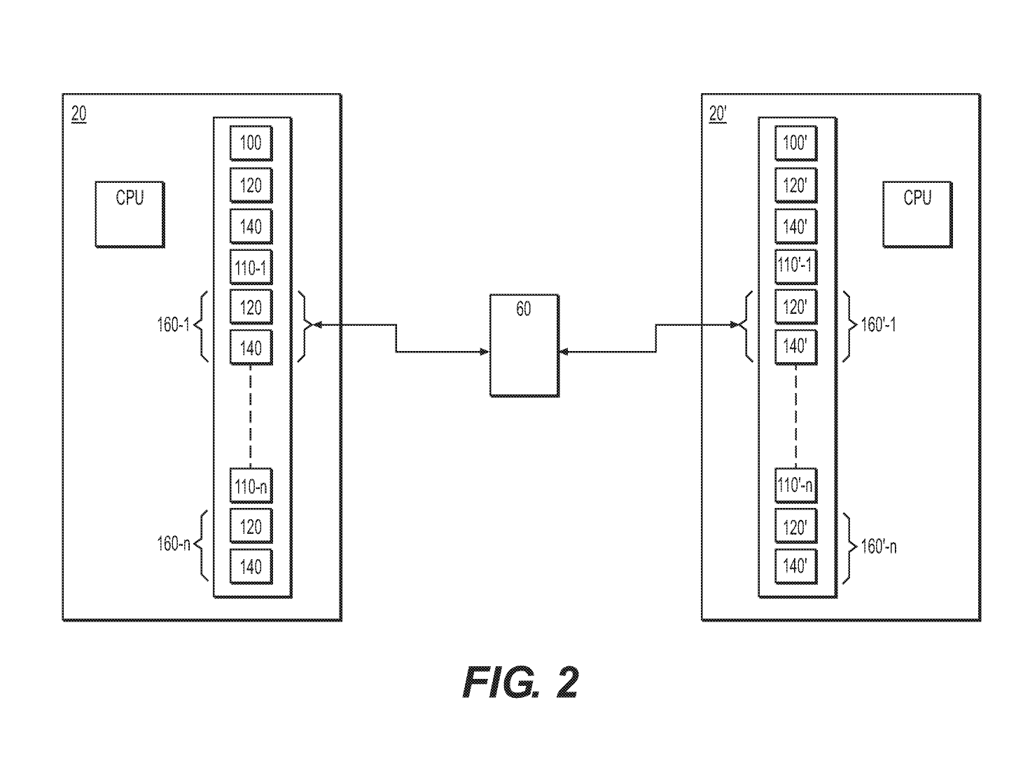

Referring to FIG. 2, a first instance of a shell or container program 100 comprises program code for a plurality of coroutines 110-1 . . . 110-n, one or more of which can be running at any given time. As well as a stack (not shown) and heap (not shown) for the container program 100, each coroutine 110 has a dedicated stack 120 and heap 140 which are located within respective context heaps 160-1 . . . 160-n. The program code for each coroutine 110 is arranged as in the example of FIG. 1 so that the each coroutine stack 120 is written to a pre-determined portion of virtual memory and so that each coroutine heap 140 is written to a contiguous portion of virtual memory, to form the context heap 160 for the coroutine 110. While for simplicity, the coroutine context heaps 160 are shown interleaved within coroutine program code in virtual memory in FIG. 2, it will be appreciated that this need not be the case and for example program code for the container program and coroutines could be grouped in one portion of virtual memory with the various context heaps 160 in another portion. The same applies to the second apparatus 20′ which will resume processing.

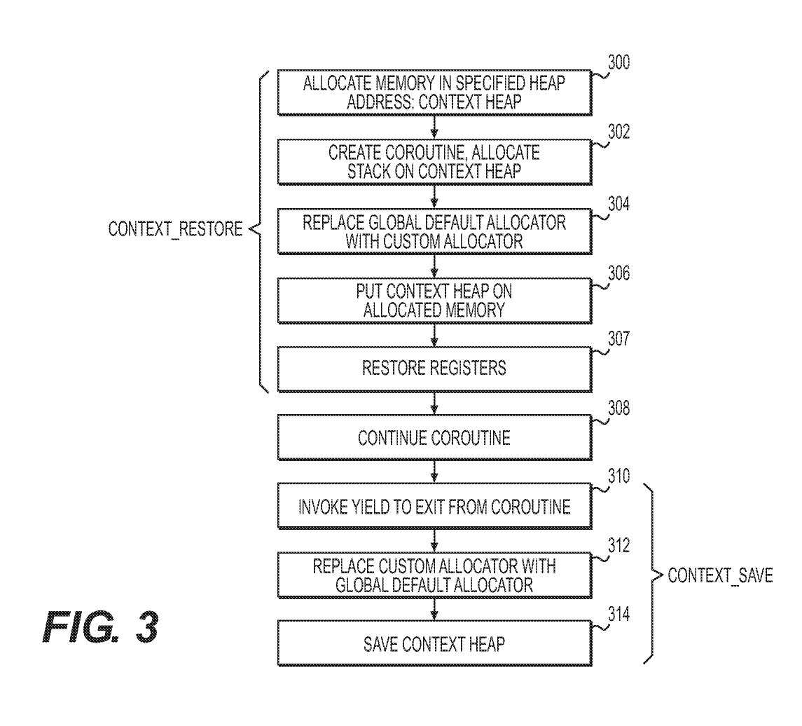

Referring to FIG. 3 which illustrates the operation of an instance of coroutine which is to cease (and/or resume) processing at an intermediate stage of data processing. At step 300, before passing control to the coroutine, virtual memory is allocated for the coroutine. Control can be explicitly passed by the container program 100 to the coroutine or the control can be gained from another coroutine which yields control to the specified coroutine. At step 302, the coroutine is instantiated (an instance is created) and the function necessary to ensure the coroutine stack is allocated within the context heap portion of memory for the instant coroutine is invoked. At step 304, if is not already the case globally for the program 100, the heap allocator, for example, equivalent to new( ) or malloc( ) is overloaded to ensure the coroutine heap is allocated within the context heap portion of memory for the instant coroutine.

At step 306, the coroutine determines if it resuming processing of data or if it the first instance of coroutine to process data. Clearly, the presence of intermediate data in a copied context heap 60, FIG. 2, corresponding to the coroutine indicates that the coroutine is to continue processing and in this case, the copied context heap information 60 is copied to the context heap 160′ for the coroutine and at step 307, any required registered are initialised in a manner similar to the way in which context is switched between coroutines running within a single instance of a program on a given processor. As an alternative to checking for the presence of a corresponding copied context heap, other signalling can also be employed to indicate to an instance of coroutine whether it is the first or subsequent instance of the routine by using run time parameters, for example, signalling if and where the coroutine can find the required context heap information 60.

On the other hand, if this is the first instance of the coroutine, then steps 306 and 307 can be skipped.

At step 308, the coroutine can now commence (or re-commence) processing in an otherwise conventional manner. At step 310, the coroutine yields either in response to user interaction or automatically. Processing can either be intended to revert back to the container program or to swap to another coroutine of the program 100, 100′. If other coroutines or the container program are not necessarily to be able to cease and resume as described, the custom allocator which determines that heap information is written to the context heap 160 for the coroutine is replaced with the default allocator at step 312. The context heap 160 for the coroutine can now be copied to persistent memory 60, step 314, where it can be accessed by a subsequent counterpart instance of the coroutine for further processing in due course.

It should be appreciated from the above description that steps 300-307 of the above example are the steps required to ensure a coroutine can restart reliably based on the previous processing and that these steps are generic to any program and can be implemented as a common function such as context_restore. Steps 310-314 are the steps required to enable a coroutine to cease processing and again are generic and can be implemented as a common function such as context_save, each of the functions context_restore and context_save being available to program developers who wish to enable programs to operate as described above.

The second embodiment in particular enables a program to run numerous operations, in this case implemented as coroutines, in parallel and independently with the possibility of transferring execution of specific operations to another computing apparatus as required.

The container program or possibly other coroutines can decide where and when a given operation should be executed and a given coroutine performing an operation may not know who called it and where from the operation was called.

It will be appreciated that while the above method has been described for exemplary purposes with a specific sequence of steps, the various steps can be rearranged where possible to achieve the same effect.

Embodiments of the present invention find particular utility in for example, the distribution of computing processes between devices; facilitating processing in virtual machines where for example processing and/or decision making can be moved between a remote server and local processors; backup\virtualization systems; and in compilers and code executing applications.

In the context of the present specification, unless expressly provided otherwise, a “server” is a computer program that is running on appropriate hardware and is capable of receiving requests (e.g. from computing apparatus) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless expressly provided otherwise, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first apparatus” and “third apparatus” is not intended to imply any particular order, type, chronology, hierarchy or ranking (for example) of/between the apparatus, nor is their use (by itself) intended imply that any “second apparatus” must necessarily exist in any given situation. Further, as is discussed herein in other contexts, reference to a “first” element and a “second” element does not preclude the two elements from being the same actual real-world element. Thus, for example, in some instances, a “first” apparatus and a “second” apparatus may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

One skilled in the art will appreciate when the instant description refers to “receiving data” from a user that the computing apparatus executing receiving of the data from the user may receive an electronic (or other) signal from the user. One skilled in the art will further appreciate that displaying data to the user via a user-graphical interface (such as the screen of the computing apparatus and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as an optical connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims

1. A method of data processing comprising:
a) a first instance of a computer program allocating a first contiguous portion of memory for storing program heap variables;
b) said first instance processing data including storing the entirety of the declared heap variables in said program heap;
c) responsive to said first instance ceasing data processing, copying the entirety of said first contiguous portion of memory to persistent memory;
d) a second instance of said computer program allocating a second contiguous portion of memory for storing the declared program heap variables, said second contiguous portion of memory being at least as large as said first contiguous portion of memory;
e) said second instance copying said persistent memory into said second contiguous portion of memory; and
f) said second instance resuming processing data based on the declared heap variables stored in said program heap in said second contiguous portion of memory.

2. A method according to claim 1 comprising instantiating said first instance on a first computing apparatus and instantiating said second instance on a second different computing apparatus.

3. A method according to claim 1 wherein the first and second computing apparatus are the same computing apparatus.

4. A method according to claim 1 wherein said persistent memory comprises one of computer memory or non-volatile memory accessible to each of said first and second instances.

5. A method according to claim 1 further comprising: said first instance storing a program stack in said first contiguous portion of memory; said first instance storing local variables in said stack; said second instance allocating a portion of said second contiguous portion of memory for storing a program stack; and said second instance resuming processing data based on heap variables stored in said program stack in said second contiguous portion of memory.

6. A method according to claim 5 in which said program is a multithreaded program, each thread having its own stack and each stack being stored in said first contiguous portion of memory.

7. A method according to claim 1 further comprising: said first instance storing at least one processor register value in said persistent memory when said first instance is to cease processing; said second instance copying said processor register values from said persistent memory; and said second instance resuming processing data based on said one or more processor register values.

8. A method according to claim 1 wherein said computer program comprises a plurality of coroutines, each instance of coroutine being arranged to perform steps a) to f).

9. A method according to claim 1 wherein said program comprises a memory allocation function for heap variables replacing a default memory allocation function which would otherwise allocate memory for heap variables in non-contiguous portions of memory.

10. A method according to claim 1 wherein said program is a compiled C program and wherein steps a) and d) are implemented with an overloaded malloc( ) function.

11. A method according to claim 1 wherein said program is a compiled C++ program and wherein steps a) and d) are implemented with an overloaded new( ) function.

12. A method according to claim 1 wherein said memory is virtual memory.

13. A method according to claim 1 wherein after ceasing data processing, said program either exits or pauses.

14. A computer program product comprising executable instructions stored on a computer readable medium which when executed on a computing apparatus are arranged to perform the method of claim 1.

15. A data processing system comprising a first computing apparatus and a second computing apparatus connected via a persistent memory, the first computing apparatus being arranged to first instantiate a computer program and allocate a first contiguous portion of memory for storing program heap variables, said first instance of computer program processing data including storing the entirety of the declared variables in said program heap; and responsive to said first instance ceasing data processing, said first instance of computer program copying said first contiguous portion of memory to said persistent memory; said second computing apparatus being arranged to subsequently instantiate said computer program and allocate a second contiguous portion of memory for storing program heap variables, said second contiguous portion of memory being at least as large as said first contiguous portion of memory;
said subsequent instance of said computer program copying said persistent memory into said second contiguous portion of memory; and resuming processing data based on the declared variables stored in said program heap in said second contiguous portion of memory.

16. A system according to claim 15 wherein said first and second computing apparatus comprise different apparatus.
